(19) United States
(12) Patent Application Publication
(10) Pub. No.: US 2010/0230531 A1
(43) Pub. Date: Sep. 16, 2010

(54) AVIAN DETERRENCE SYSTEM AND METHOD

(76) Inventors: FAYED O. FAYED, PARKLAND, FL (US); FRANK CARMEL CERAVOLO, AUSTIN, TX (US)

Correspondence Address: James David Johnson, P.A., 401 East Las Olas Boulevard, Suite 130-290, Fort Lauderdale, FL, 33301, US

(21) Appl. No.: 12/709,486

(22) Filed: Feb. 21, 2010

Related U.S. Application Data
(60) Provisional application No. 61/202,359, filed on Feb. 20, 2009.

(51) Int. Cl. B64B 1/00; F41B 11/00; B64B 1/40; F42B 4/00; G05D 1/00

(52) U.S. Cl. 244/30; 124/56; 244/31; 102/357; 701/2; 102/356

(57) ABSTRACT

Systems and methods are described for deterring birds from flying into airspace above airport runways. The system features at least one mortar for firing a pyrotechnic device to produce a light and sound display for the purpose of disturbing, frightening, and harassing birds so as to deter them from flying into airspace above and in the vicinity of an airport runway. The mortars of the system can be installed on a mounting platform capable of being securely connected to the ground or a ground surface substrate or to a vehicle. Fixed position, movable and portable embodiments of the system may be created and used. The light and sound display produced by the exploding pyrotechnic devices can be varied to prevent the birds from becoming desensitized to the sounds and visual effects of the system. The system may also include deterrent chemicals.

### CROSS-REFERENCE TO RELATED APPLICATION

This application claims the priority from U.S. provisional patent application Ser. No. 61/202,359 filed Feb. 20, 2009. The foregoing application is incorporated in its entirety herein by reference.

### FIELD OF THE INVENTION

The invention relates to animal deterrence systems and methods. More particularly, the invention relates to systems and methods for deterring birds, bats, and other animals from entering a particular airspace or other location.

### BACKGROUND

The danger of collisions with birds and other flying animals presents a constant risk to the flight of airplanes and other aircraft. Primarily, these “bird strikes” occur during takeoff and landing of aircraft around airport runways and in the airspace above the runways. The majority of these bird strikes occur at less than 1,000 feet above the ground, with nearly three quarters of such strikes occurring at an altitude of 500 feet or less.

In addition to the safety hazard created by birds flying above and around airport runways, birds may also present a nuisance in agricultural areas to certain crops and to aquaculture farms, which may lose a significant percentage of their production to avian feeding.

Currently, no products are available that can effectively deter birds from entering into and occupying airspace above airport runways and above other locations in which the presence of birds is not desired. Conventional devices attempt to scare birds off of runways; however, the birds merely take flight in the airspace above the runway, which can actually increase the risk of collisions with incoming and outbound aircraft.

A need exists for a deterrence system that can frighten birds off of the ground and deter them from entering into and occupying airspace above airport runways and other areas in which the presence of birds is not desired by humans.

### SUMMARY

The invention relates to systems and methods for deterring birds from flying into an airspace above airport runways and other areas in which the birds are a nuisance or pose safety hazards. The system can feature at least one mortar for firing a pyrotechnic device to produce a light and sound display for the purpose of disturbing, frightening, and harassing birds so as to deter them from flying into the airspace. The mortars can be installed on a mounting platform capable of being secured to the ground or a ground surface substrate or to a vehicle. The system can be manufactured in fixed position, movable and portable embodiments for use in various circumstances such as, for example, around airports, aircraft carriers, military bases, and farms. The light and sound display produced by the exploding pyrotechnic devices can be varied to prevent the birds from becoming desensitized to the sounds and visual effects of the system. The system may also include deterrent chemicals.

Birds are deterred from entering into and remaining in restricted airspace, e.g., landing paths and runways of airports and their surrounding vicinities. The deterrence system triggers the animal's survival instinct so that they leave and avoid the airspace and area in which the system is used. The system relies on the basic principal that all avian species will flee a perceived threat, and therefore, can be conditioned to associate certain visual and audio stimuli with specific threats. By using the system frequently, either randomly or at predetermined intervals, birds can be deterred from entering an airspace because, through repetition of use, the birds perceive a continuous, ongoing threat.

The systems and methods of the invention are advantageous in deterring birds and other animals from entering into or occupying an airspace or ground area in which their presence is not desired for safety or economic reasons. One advantage of the system over conventional deterrent systems is that it can be used to disturb, chase away, and deter birds from taking flight and soaring in the airspace above the area from which their presence needs to be restricted.

Accordingly, the invention features a system for deterring flying animals from entering an airspace. The system can include a mounting plate, a pyrotechnic device, at least one mortar for firing the pyrotechnic device, a launching mechanism electrically connected to the mortar, a receiver communicatively connected to the launching mechanism, an antenna communicatively connected to the receiver, and a remote control device. The mortar can be secured to the mounting plate. The remote control device can be used to transmit a signal to the receiver to cause the launching mechanism to actuate the mortar to launch the pyrotechnic device into the airspace. Once launched into the airspace, the pyrotechnic device can explode to deter flying animals from entering into or occupying the airspace.

In another aspect, the invention can feature the mounting plate being capable of attaching to a vehicle selected from among an automobile, an aircraft, a boat, a train, an airship, or a balloon.

In another aspect, the invention can feature movement of the vehicle being remotely controlled.

In another aspect, the invention can feature the vehicle including design elements that mimic the appearance of a predator animal.

In another aspect, the invention can feature the mounting plate being capable of attachment to the ground or to a manmade ground surface substrate.

In another aspect, the invention can feature the airspace being located above or proximal to at least one location selected among an airport, a landing strip, a heliport, a runway, a landing pad, a landing path adjacent to an airport, an aircraft carrier vessel, or a farm.

In another aspect, the invention can feature the pyrotechnic device exploding after launching to produce a light and sound display.

In another aspect, the invention can feature the pyrotechnic device further including an animal deterrent chemical.

In another aspect, the invention can feature the at least one mortar including a plurality of mortars each of which is capable of firing the pyrotechnic device to a different altitude.

In another aspect, the invention can feature each of the plurality of mortars including a marking to identify the altitude to which each of the plurality of mortars is capable of launching the pyrotechnic device.

In another aspect, the invention can feature the mortar including explosive means for launching the pyrotechnic device.

In another aspect, the invention can feature the mortar including compressed air means for launching the pyrotechnic device.

In another aspect, the invention can feature the system further including a computer and software installed thereon to automate control of the system.

In another aspect, the invention can feature the system being suspended from an inflatable device.

In another aspect, the invention can feature the inflatable device including a gas-inflated device selected from the group consisting of: an airship and a balloon.

In another aspect, the invention can feature the system further including an effigy.

In another aspect, the invention can feature the system further including a speaker communicatively connected to an audio playback device, wherein the audio playback device plays preselected audio media that is played through the speaker.

In another aspect, the invention can feature the flying animals being birds and bats.

The invention also features a system for deterring animals from entering into or occupying an airspace or an area on the ground. The system can feature a handheld launching device, and a pyrotechnic device capable of being launched into an airspace by the handheld launching device. The pyrotechnic device can feature at least one composition for producing a light and sound display in the airspace and at least one animal deterrent chemical.

A method of the invention can be used to deter flying animals from entering into airspace above an aircraft runway or launch pad. The method can include the steps of launching a pyrotechnic device from a mounting platform into an airspace and exploding the pyrotechnic device in the airspace to create a light and sound display and to emit at least one animal deterrent chemical.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a left side view of one embodiment of a system of the invention.

FIG. 2 is a right side view of the embodiment of the system of FIG. 1.

FIG. 3 is a top view of another embodiment of a system of the invention.

FIG. 4 is a perspective view of the embodiment of the system shown in FIG. 3 mounted to an airplane.

FIG. 5 is a perspective view of another embodiment of a system of the invention mounted to an automobile.

FIG. 6 is a perspective view of another embodiment of a system of the invention mounted to a boat.

FIG. 7 is a perspective view of another embodiment of a system of the invention tethered to an airship.

FIG. 8 is a side view of a handheld portable embodiment of a system of the invention.

### DETAILED DESCRIPTION

The invention provides a deterrence system for disturbing, frightening, or otherwise deterring animals, and particular flying animals, from entering into or occupying a particular volume of airspace. The system can also be used to deter animals from entering or occupying areas of ground, the interior of buildings, or underground areas such as caves and mines. The system is particularly useful in deterring birds from entering into an airspace; however, the system may also be used to deter bats from entering airspace or to deter non-flying animals from entering into certain areas on the ground. While the systems and methods described herein are useful for deterring non-avian animal species from entering into airspace and other areas, for purposes of convenience only and without any intent to limit the usage of the invention, hereinafter, the invention will be described in reference to its usage in deterring birds.

Users may wish to use the system to deter birds from entering airspaces located above or proximal to locations such as, for example, an airport, a landing strip, a heliport, a runway, a landing pad, a landing path adjacent to an airport, an aircraft carrier vessel, or a farm. Farms at which the system can be used to deter the presence of birds can include fields of crops, pastures, and aquaculture facilities.

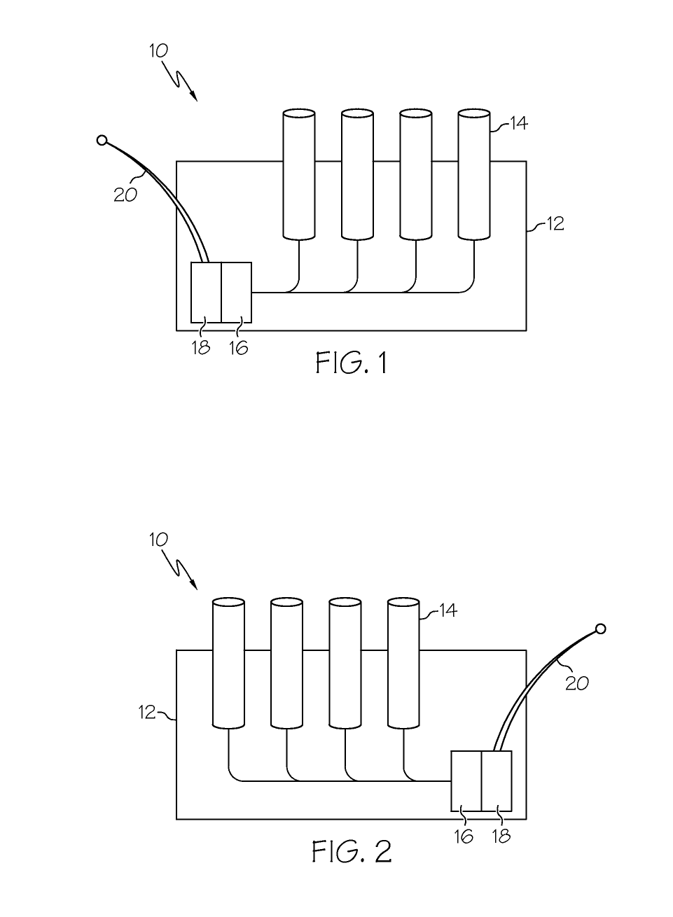

As shown in FIGS. 1-3, the deterrence system can include a mounting plate or platform, a pyrotechnic device, at least one mortar for firing the pyrotechnic device, a launching mechanism electrically connected to the mortar, a receiver communicatively connected to the launching mechanism, an antenna communicatively connected to the receiver, and a remote control device. The mortar can be secured to the mounting plate. The remote control device can be used to transmit a signal to the receiver to cause the launching mechanism to actuate the mortar to launch the pyrotechnic device into the airspace. The pyrotechnic device can explode after launching into the airspace to deter flying animals from entering into or occupying the airspace. The embodiment of the system shown in FIG. 1-2 features a mounting plate that can be attached to the ground or to a manmade ground surface substrate such as a paved runway or tarmac.

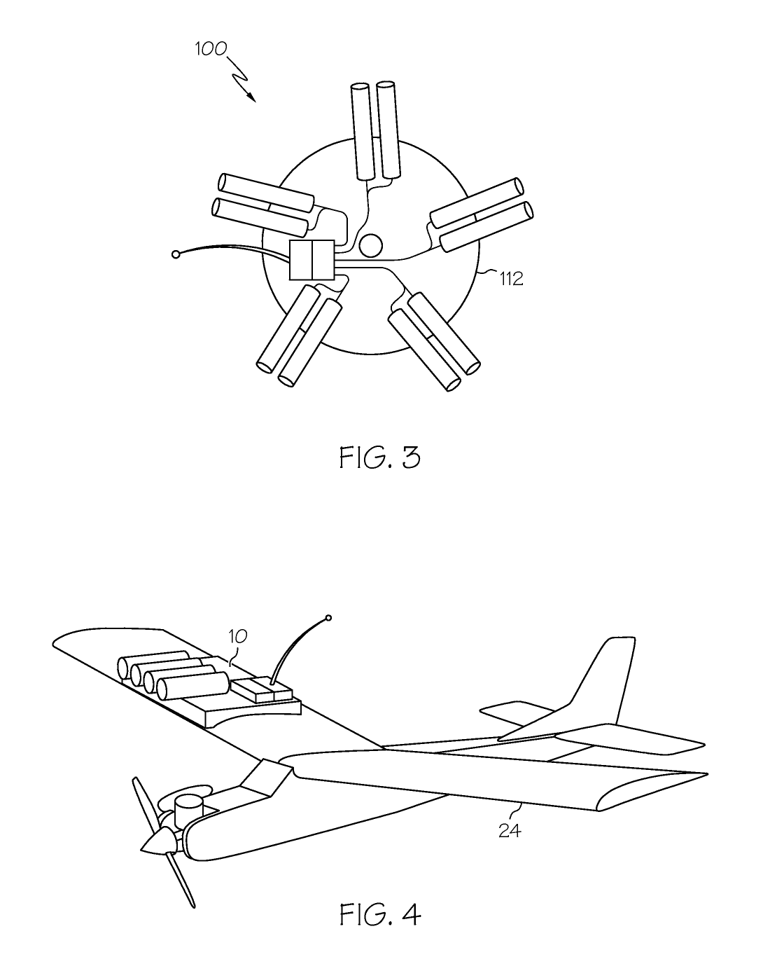

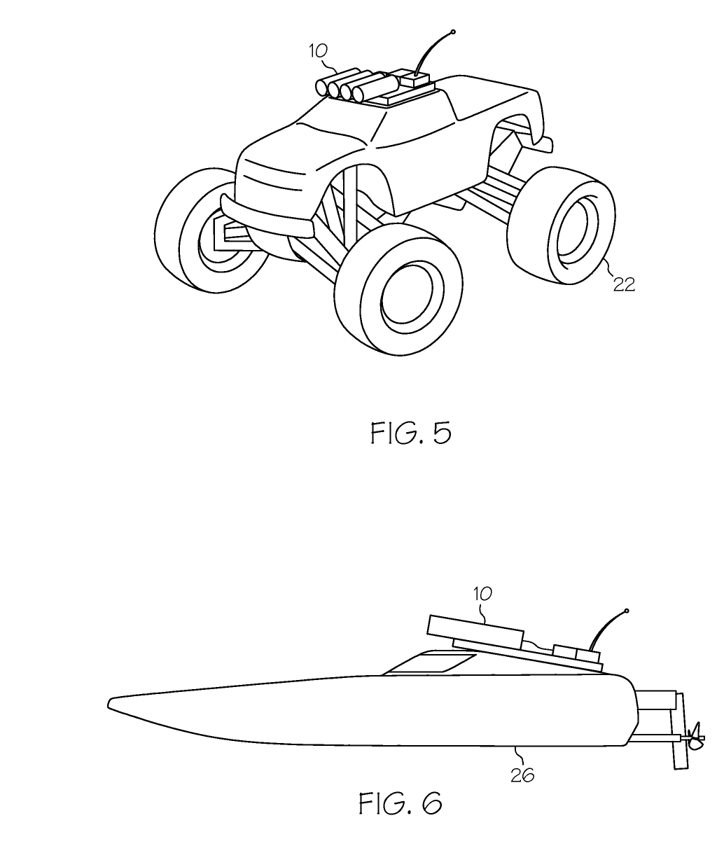

The embodiment of the system shown in FIG. 3 includes a mounting plate that is particularly well suited for installation on a vehicle. The mounting plate can be attached to the vehicle using any suitable fastener or by welding. As shown in FIGS. 4-6, the system can be attached to vehicles such as, for example, an automobile, an aircraft, a boat, a train, an airship, or a balloon. The movement of the vehicle can be remotely controlled, piloted or driven by a human, or automated by a computer.

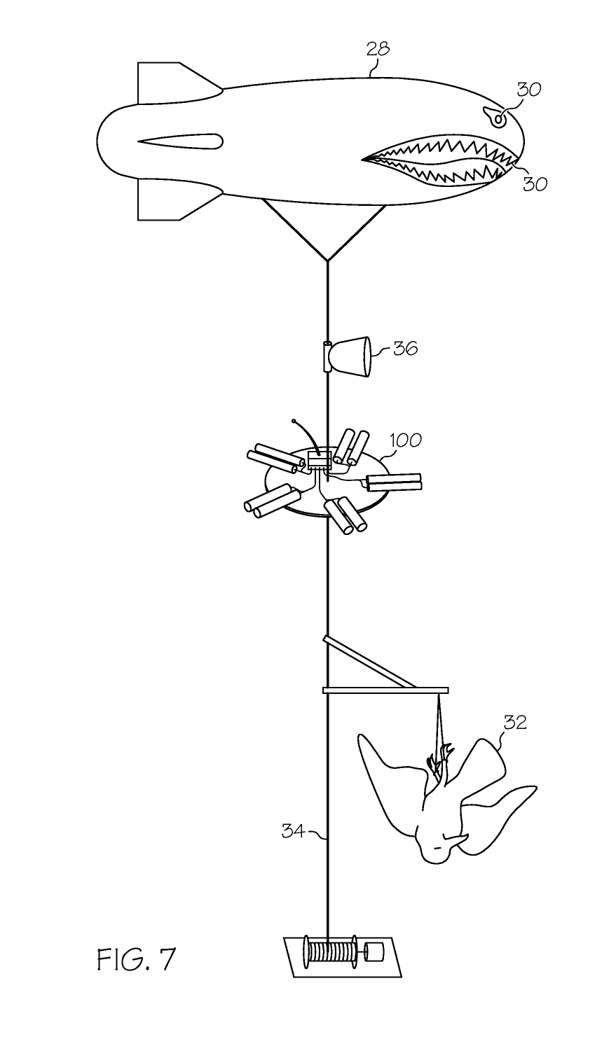

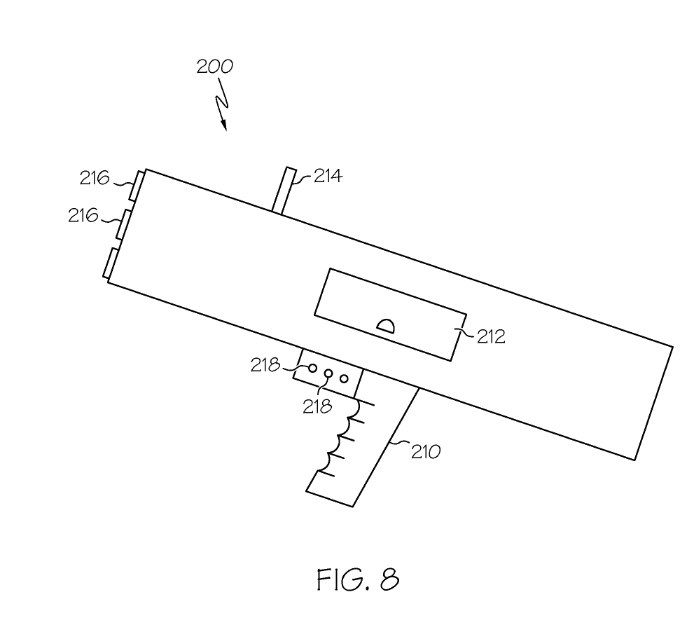

As shown in FIG. 7, the system can be suspended from a vehicle that is an inflatable device. The inflatable device can be a gas-inflated device such as, for example, an airship and a balloon. The gas-inflated device can be free floating, self-propelled, or tethered to the ground or to another object, e.g., a building. Airships may be free floating and their movement may be controlled remotely by a user or by a computer. Balloons can be tethered to the ground or to an object or building. The gas-inflated device can be floated to an altitude of 100, 200, 250, 300, 400, 500, 750, 1000, 1500, 2000, 2500 feet or higher depending upon the species of bird desired to be deterred and the requirements of the user.

The vehicle may include design elements that mimic the appearance of a predator animal. Design elements suitable for the intended purpose may include, for example, images of eyes or teeth painted on the vehicle or attached by adhesive stickers. The design elements can be recognized by birds and, in addition to other deterrent aspects of the system, serve to further disturb and frighten the birds so that they avoid the airspace in which their presence is not desired. Aircraft, airships, and balloons to which the system is connected are particularly well suited for the implementation and use of design elements on their exterior surfaces.

The mortar can be a tube, e.g., a metal tube, capable of launching or firing the pyrotechnic device. The launching mechanism can feature gunpowder or another explosive composition to fire the pyrotechnic device into the airspace. In another embodiment, the launching mechanism can feature compressed air means such as an air compressor or compressed air cartridge to launch or propel the pyrotechnic device into the airspace. In an exemplary embodiment, the system can include a plurality of mortars. Each of the plurality of mortars can feature a marking to identify the altitude to which each mortar is capable of launching the pyrotechnic device. For example, mortars capable of launching the pyrotechnic device 50, 100, 250, 500, 750, 1000, 1500, 2000, 2500 feet or more may be used with the system. In this way, the height of pyrotechnic devices launched by the system can be varied.

The pyrotechnic device can be similar to a traditional firework in that it can produce a light and sound display after being fired by the mortar. The light and sound display can feature bright flashes of light once the pyrotechnic device reaches a predetermined altitude, speed, or point in its trajectory. The flashes of light may be white light or colored light. The flashes of light may also feature sparks. The light and sound display can include several noise effects including but not limited to a whistling sound sometimes associated with screamer-type fireworks, pops and crackling sounds, humming and whizzing noises, and reports (also known as bangs). In one embodiment, only a single type of pyrotechnic device is used with the system; however, in an exemplary embodiment, multiple types of pyrotechnic devices can be deployed with the system. By using multiple types of pyrotechnic devices, the light and sound display created by the system in the airspace can be varied. Varying the light and sound display can assist in preventing the animals from becoming desensitized to the noises and visual displays that are created when the pyrotechnic device is fired into the airspace and exploded.

In one embodiment, the timing and location of the explosion can be controlled by a human user or by a computer.

In an exemplary embodiment, the pyrotechnic device can also feature one or more animal deterrent chemical such as, for example, grape seed extract. The animal deterrent chemical can be non-toxic to humans. In an exemplary embodiment, the animal deterrent chemical is also non-toxic to birds and other animals.

The launching of the pyrotechnic devices can be remotely controlled by a human user using a remote control device. In another embodiment, the launching of the pyrotechnic devices can be controlled using a computer and software installed thereon.

In one embodiment, the system can feature an effigy. The effigy can be designed to imitate the appearance of a dead bird or the appearance of a predator species. The effigy may be installed on the ground or suspended from a vehicle of the system. The effigy may be suspended from and connected to the vehicle, e.g., to an aircraft, airship, or balloon, by a tether apparatus. Any suitable tether apparatus may be used with the system such as, for example, a rope or chain.

The system can also feature a speaker communicatively connected to an audio playback device for playing preselected audio media. The preselected audio media can include recordings of the sounds of predator animals or other noises intended to disturb, frighten, and deter birds from entering into and occupying an airspace or ground location. The speaker can be installed on the ground, mounted on the vehicle, or suspended from a floating or flying vehicle.

As shown in FIG. 8, the invention can also feature a portable system for deterring animals from entering into or occupying an airspace or an area on the ground. The portable system can feature a handheld launching device and a pyrotechnic device capable of being launched into an airspace by the handheld launching device. The portable system can be similar to a gun, flare launcher, grenade launcher, or missile launcher. The portable system can be constructed to have an appearance that does not alarm airport passengers or other individuals who otherwise might mistake the system for a weapon. The pyrotechnic device can feature at least one composition for producing a light and sound display in the airspace and at least one animal deterrent chemical.

The handheld launching device can include a grip for manually holding the device and a reloading hatch through which pyrotechnic devices can be loaded into the device. The handheld launching device may also feature a sight to assist the user with more accurate aiming before launching or firing the pyrotechnic device into the airspace.

The handheld launching device of the portable system can feature a single barrel and barrel opening or multiple barrels each having a separate barrel opening. In embodiments of the portable system that include a plurality of barrels, the handheld launching device can include a plurality of buttons, switches, or other types of actuators, each of which can be used to activate one of the plurality of barrels for launching of the pyrotechnic device from that barrel. The buttons, switches or other types of actuators may be color-coded or otherwise marked so as to render each actuator readily identifiable to the user as controlling one particular barrel of the plurality of barrels. In other embodiments, the color-coding or other markings may be included to identify each barrel by the type of effects capable of being produced by the pyrotechnic device loaded therein. In an exemplary embodiment, the color-coding can be used to identify each barrel relative to the range, distance, or altitude to which each barrel is capable of launching a pyrotechnic device loaded therein.

The invention also features methods for deterring birds from entering into an occupying an airspace or ground area. The method can include the steps of launching a pyrotechnic device from a mounting platform into an airspace and exploding the pyrotechnic device in the airspace to create a light and sound display and to emit at least one animal deterrent chemical. Systems such those described above can be used to accomplish the objectives of the method.

In another step of the method, units of the system can be installed around a perimeter of a target area in and above which the presence of birds is not desired. The units of the system can be strategically placed in order to be able to reach the majority of the critical airspace above when the pyrotechnic devices are launched.

In another step of the method, pyrotechnic devices can be launched at predetermined intervals. In a different embodiment, the pyrotechnic devices can be launched upon sighting birds within the target area or airspace above the target area.

In another step of the method, regular and repeated patrols may be conducted throughout the day in and around the target area. As birds are sighted during the patrols, pyrotechnic devices may be launched into the airspace of the target area to frighten and chase birds away from the area and out of the airspace as needed. A combination of multiple vehicles of the system can be used with the method.

Vehicles such as the airship and balloon can be allowed to rise into the airspace regularly or may be fixed within the airspace at a defined altitude. Use of floating vehicles is particularly useful to deter birds from soaring in the airspace. The method can include the steps of displaying an effigy mimicking a dead bird or a predator animal. The effigy can be suspended from a floating vehicle such as the airship and balloon. The floating vehicle can also be tethered close to the ground and allowed to rise only as needed when birds are present.

In another step of the method, a speaker can be used to play prerecorded bird distress calls or other noises intended to disturb, frighten, and deter birds from entering into and occupying the airspace or ground area.

With repeated use and continuous harassment of the birds coupled with visual and audio stimuli created by the systems of the method, birds will begin to associate the airspace or ground area with danger and may develop a fear of the vehicle disguised to look like a predator using design elements as described herein.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for deterring flying animals from entering an airspace, the system comprising:
a mounting plate;
at least one mortar for firing a pyrotechnic device, wherein the at least one mortar is secured to the mounting plate;
a launching mechanism electrically connected to the mortar;
a receiver communicatively connected to the launching mechanism;
an antenna communicatively connected to the receiver; and
a remote control device for transmitting a signal to the receiver to cause the launching mechanism to actuate the mortar to launch the pyrotechnic device into an airspace where the pyrotechnic device can explode to deter flying animals from entering into or occupying the airspace.

2. The system of claim 1, wherein the mounting plate is capable of attaching to a vehicle selected from the group consisting of: an automobile, an aircraft, a boat, a train, an airship, and a balloon.

3. The system of claim 2, wherein movement of the vehicle is capable of being remotely controlled.

4. The system of claim 2, wherein the vehicle comprises design elements that mimic the appearance of a predator animal.

5. The system of claim 1, wherein the mounting plate is capable of being attached to the ground or to a manmade ground surface substrate.

6. The system of claim 1, wherein the airspace is located above or proximal to at least one location selected from the group consisting of: an airport, a landing strip, a heliport, a runway, a landing pad, a landing path adjacent to an airport, an aircraft carrier vessel, and a farm.

7. The system of claim 1, wherein the pyrotechnic device explodes after launching to produce a light and sound display.

8. The system of claim 1, wherein the pyrotechnic device further comprises an animal deterrent chemical.

9. The system of claim 1, wherein the at least one mortar comprises a plurality of mortars each of which is capable of firing the pyrotechnic device to a different altitude.

10. The system of claim 9, wherein each of the plurality of mortars comprises a marking to identify the altitude to which each of the plurality of mortars is capable of launching the pyrotechnic device.

11. The system of claim 1, wherein the mortar comprises explosive means for launching the pyrotechnic device.

12. The system of claim 1, wherein the mortar comprises compressed air means for launching the pyrotechnic device.

13. The system of claim 1, wherein the system further comprises a computer and software installed thereon to automate control of the system.

14. The system of claim 1, wherein the system is suspended from an inflatable device.

15. The system of claim 14, wherein the inflatable device comprises a gas-inflated device selected from the group consisting of: an airship and a balloon.

16. The system of claim 1, wherein the system further comprises an effigy.

17. The system of claim 1, wherein the system further comprises a speaker communicatively connected to an audio playback device, wherein the audio playback device plays preselected audio media that is played through the speaker.

18. The system of claim 1, wherein the flying animals comprise birds and bats.

19. A system for deterring animals from entering into or occupying an airspace or an area on the ground, the system comprising:
a handheld launching device;
a pyrotechnic device capable of being launched into an airspace by the handheld launching device, wherein the pyrotechnic device comprises at least one composition for producing a light and sound display in the airspace and at least one animal deterrent chemical.

20. A method for deterring flying animals from entering into airspace above an aircraft runway or launch pad, the method comprising the steps of:
(a) launching a pyrotechnic device from a mounting platform into an airspace; and
(b) exploding the pyrotechnic device in the airspace to create a light and sound display and to emit at least one animal deterrent chemical.
